(19) United States
(12) Patent Application Publication
(10) Pub. No.: US 2025/0258063 A1
(43) Pub. Date: Aug. 14, 2025

(54) ANOMALY FACTOR ESTIMATION SYSTEM, METHOD, AND STORAGE MEDIUM

(71) Applicant: KABUSHIKI KAISHA TOSHIBA, Tokyo (JP)

(72) Inventors: Hiroyuki Yanagihashi, Yokohama Kanagawa (JP); Takashi Sudo, Fuchu Tokyo (JP); Kouta Nakata, Chigasaki Kanagawa (JP)

(73) Assignee: KABUSHIKI KAISHA TOSHIBA, Tokyo (JP)

(21) Appl. No.: 19/040,028

(22) Filed: Jan. 29, 2025

(30) Foreign Application Priority Data
Feb. 8, 2024 (JP) 2024-017798

(51) Int. Cl. G01M 99/00; G06F 16/22

(52) U.S. Cl. CPC G01M 99/005; G06F 16/2237

(57) ABSTRACT

According to one embodiment, an anomaly factor estimation system includes a processor. The processor extracts a first acoustic feature amount based on a frequency, time, and signal intensity from sound data. The processor calculates a first reconstruction error that is a difference between the first acoustic feature amount and a reconstructed feature amount obtained by reconstructing the first acoustic feature amount based on a reconstruction model. The processor estimates an anomaly factor by performing vector search in a database with a query vector based on the first reconstruction error. The database stores a plurality of anomaly factors and of sample vectors based on a plurality of second reconstruction errors in association with each other.

### CROSS-REFERENCE TO RELATED APPLICATIONS

This application is based upon and claims the benefit of priority from Japanese Patent Application No. 2024-017798, filed Feb. 8, 2024, the entire contents of which are incorporated herein by reference.

### FIELD

Embodiments described herein relate generally to an anomaly factor estimation system, a method, and a storage medium.

### BACKGROUND

In infrastructure facilities including industrial equipment, periodic inspections are performed to maintain safety. Anomaly in facilities often appears as sounds. For this reason, there is a technique for detecting an anomaly in facilities by acquiring an operating sound of the facilities using a microphone or the like and analyzing a state of the operation sound.

As a technique for detecting an anomaly from an operating sound, there is a technique for estimating an anomaly factor according to a frequency. However, if the operating sound includes many variations of the anomaly, it is difficult to design a correspondence between the frequency and the anomaly factor.

### BRIEF DESCRIPTION OF DRAWINGS

FIG. 1 is a diagram illustrating a configuration example of an anomaly factor estimation system according to a first embodiment.

FIG. 2 is a diagram illustrating a configuration example of an information processing apparatus illustrated in FIG. 1.

FIG. 3 is a diagram illustrating a processing procedure of an anomaly factor estimation process according to the first embodiment.

FIG. 4 is a diagram schematically illustrating a processing procedure of an anomaly factor estimation process according to the first embodiment.

FIG. 5 is a diagram illustrating a display screen.

FIG. 6 is a diagram illustrating a configuration example of an information processing apparatus according to a second embodiment.

FIG. 7 is a diagram illustrating a processing procedure of an anomaly factor estimation process according to the second embodiment.

FIG. 8 is a diagram schematically illustrating a processing procedure of an anomaly factor estimation process according to the second embodiment.

FIG. 9 is a diagram illustrating types of anomaly factors.

FIG. 10 is a diagram illustrating a display screen.

FIG. 11 is a diagram illustrating a configuration example of an information processing apparatus according to a third embodiment.

FIG. 12 is a diagram illustrating a processing procedure of an anomaly factor estimation process according to the third embodiment.

FIG. 13 is a diagram schematically illustrating a processing procedure of an anomaly factor estimation process according to the third embodiment.

FIG. 14 is a diagram illustrating a configuration example of an information processing apparatus according to a fourth embodiment.

FIG. 15 is a diagram illustrating a processing procedure of an anomaly factor estimation process according to the fourth embodiment.

FIG. 16 is a diagram schematically illustrating a processing procedure of an anomaly factor estimation process according to the fourth embodiment.

FIG. 17 is a diagram illustrating a configuration example of an information processing apparatus according to a fifth embodiment.

FIG. 18 is a diagram illustrating a processing procedure of a reconstruction model generation process according to a fifth embodiment.

FIG. 19 is a diagram schematically illustrating a processing procedure of an anomaly factor estimation process according to the fifth embodiment.

### DETAILED DESCRIPTION

In general, according to one embodiment, an anomaly factor estimation system includes a processor. The processor extracts a first acoustic feature amount based on a frequency, time, and signal intensity from sound data related to a target facility. The processor calculates a first reconstruction error that is a difference between the first acoustic feature amount and a reconstructed feature amount obtained by reconstructing the first acoustic feature amount based on a reconstruction model for encoding and decoding an acoustic feature amount. The processor estimates an anomaly factor of the target facility by performing vector search in a database with a query vector based on the first reconstruction error. The database stores a plurality of anomaly factors and a plurality of sample vectors based on a plurality of second reconstruction errors in association with each other.

### First Embodiment

Hereinafter, an anomaly factor estimation system, a method, and a program according to the present embodiment will be described with reference to the drawings.

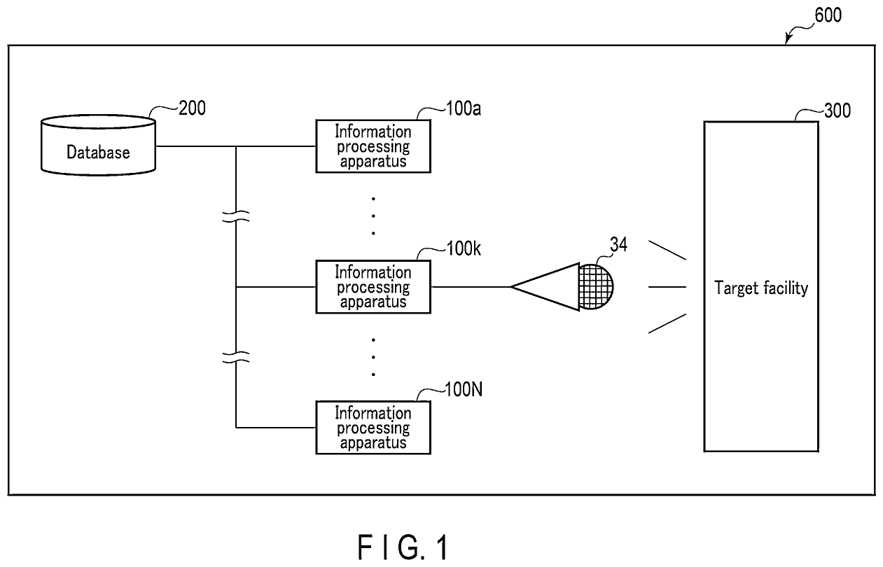

FIG. 1 is a diagram illustrating a hardware configuration example of an anomaly factor estimation system 600 according to the first embodiment. As illustrated in FIG. 1, the anomaly factor estimation system 600 includes a target facility 300, a microphone 34, N (N is a natural number of 1 or more) information processing apparatuses 100k (k is any natural number of 1 to N), and a database 200. The target facility 300 is a facility for which an anomaly factor is to be estimated. In the target facility 300, an operating sound is generated with the operation of the machine. Specifically, the target facility 300 is assumed to be a machine tool, a manufacturing apparatus, an elevator, an electrical facility, or the like. The microphone 34 collects the operating sounds emitted from the target facility 300 and gathers sound data that include digital signals of the operating sounds in chronological order. The sensing of the operating sounds by the microphone 34 is taken here as an example of a sensor, but the sensor may be assumed as a vibration sensor, an acoustic emission sensor, or the like that outputs a one-dimensional waveform signal other than sound. Each information processing apparatus 100k extracts a feature amount from the acquired sound data, generates a query vector based on the feature amount, and performs vector search in the database 200 with the query vector, thereby estimating an anomaly factor. Although not illustrated, each information processing apparatus 100k may be connected to another microphone to collect sound data from another target facility. The database 200 is a computer that stores a plurality of anomaly factors and a plurality of sample vectors based on a plurality of second reconstruction errors in association with each other. In the following description, the term information processing apparatus 100 will refer to each of the information processing apparatuses 100a to 100N without distinction. As an example, the anomaly factor estimation system 600 is a system in which the information processing apparatus 100 is set as an edge device such as a personal computer and the database 200 is set as a server computer.

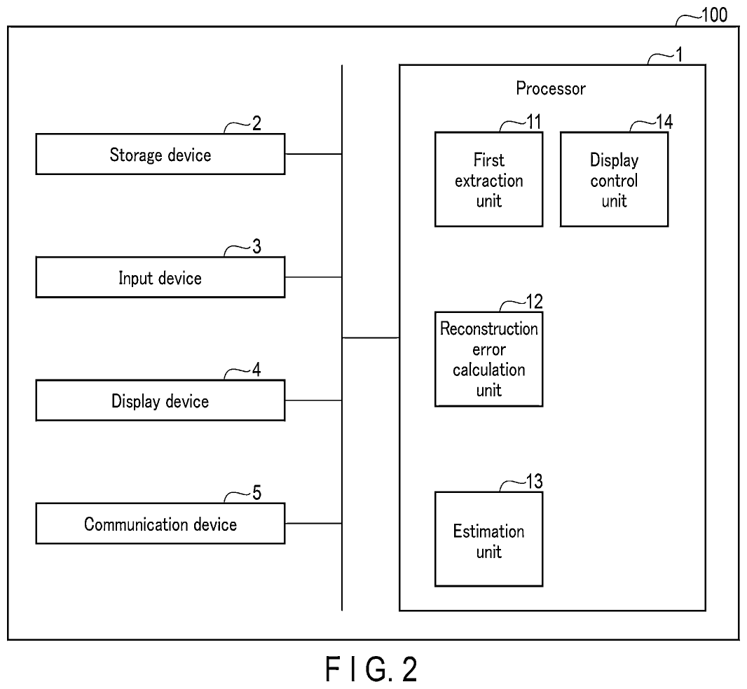

FIG. 2 is a diagram illustrating a hardware configuration example of the information processing apparatus 100. As illustrated in FIG. 2, the information processing apparatus 100 is a computer including a processor 1, a storage device 2, an input device 3, a display device 4, and a communication device 5. Transmission and reception of data and various signals among the processor 1, the storage device 2, the input device 3, the display device 4, and the communication device 5 are performed via a bus.

The processor 1 is an integrated circuit that controls the entire operation of the information processing apparatus 100. For example, the processor 1 includes a central processing unit (CPU) and a graphics processing unit (GPU), a digital signal processor (DSP), and/or a floating-point unit (FPU).

The processor 1 may include an internal memory and an I/O interface. The processor 1 executes various processes by interpreting and calculating programs stored in advance in the storage device 2 or the like. A part or the whole of the processor 1 may be implemented by hardware such as an application specific integrated circuit (ASIC) or a field programmable gate array (FPGA).

The storage device 2 is a volatile memory and/or a nonvolatile memory that stores various types of data. For example, the storage device 2 stores data and setting values used for the processor 1 to execute various processes, data generated by various processes in the processor 1, and the like. The storage device 2 includes a read only memory (ROM), a random access memory (RAM), a hard disk drive (HDD), a solid state drive (SSD), an integrated circuit storage device, and the like. The storage device 2 may include a non-transitory computer-readable storage medium that stores programs to be executed by the processor 1.

The input device 3 receives inputs of various operations from an operator. As the input device 3, a keyboard, a mouse, various switches, a touch pad, a touch panel display, a microphone, and the like can be used. An electric signal (hereinafter, operation signal) corresponding to a received operation input is supplied to the processor 1. For example, sound data corresponding to an input from the microphone 34 is supplied to the processor 1.

The display device 4 displays various data under the control of the processor 1. As the display device 4, a cathode-ray tube (CRT) display, a liquid crystal display, an organic electro luminescence (EL) display, a light-emitting diode (LED) display, a plasma display, or any other display can be used as appropriate. The display device 4 may be a projector.

The communication device 5 includes a communication interface such as a network interface card (NIC) for performing data communication with various devices connected to the information processing apparatus 100 via a network. The information processing apparatus 100 may acquire sound data collected by the microphone 34 outside the information processing apparatus 100 via the communication device 5. Note that an operation signal may be supplied from a computer connected via the communication device 5 or an input device included in the computer, or various data may be displayed on a display device or the like included in the computer connected via the communication device 5. However, in order to simplify the following description, unless otherwise specified, it is assumed that the supply source of operation signals is the input device 3 and the display destination of various data is the display device 4. The input device 3 can be replaced with a computer connected via the communication device 5 or an input device included in the computer, and the display device 4 can be replaced with a display device or the like included in the computer connected via the communication device 5.

The information processing apparatus 100 does not need to include all of the processor 1, the storage device 2, the input device 3, the display device 4, and the communication device 5. Some of the storage device 2, the input device 3, the display device 4, and the communication device 5 may not be provided as necessary. The information processing apparatus 100 may be provided with any additional hardware device useful for executing the processing according to the present embodiment. The information processing apparatus 100 does not need to be physically configured by one computer, and may be configured by a computer system including a plurality of computers communicably connected by wire or via a network line or the like. The allocation of a series of processes according to the present embodiment to the plurality of processors 1 mounted in the plurality of computers can be arbitrarily set. All the processors 1 may execute all the processes in parallel, or a specific process may be allocated to one or some of the processors 1, and a series of processes according to the present embodiment may be executed in the entire computer system.

As illustrated in FIG. 2, the processor 1 includes functional components such as a first extraction unit 11, a reconstruction error calculation unit 12, an estimation unit 13, and a display control unit 14.

The first extraction unit 11 extracts a first acoustic feature amount defined by a frequency, a time, and a signal intensity from sound data related to the target facility 300 collected by the microphone 34.

The reconstruction error calculation unit 12 calculates a first reconstruction error that is a difference between a reconstructed feature amount obtained by reconstructing the first acoustic feature amount and the first acoustic feature amount used for reconstruction of the reconstructed feature amount, based on a reconstruction model for encoding and decoding an acoustic feature amount.

The estimation unit 13 estimates an anomaly factor of the target facility 300 by performing vector search in the database 200 with a query vector based on the first reconstruction error calculated by the reconstruction error calculation unit 12.

The display control unit 14 displays various types of information on the display device 4. For example, the display control unit 14 displays the anomaly factor of the target facility 300 estimated by the estimation unit 13 on the display device 4.

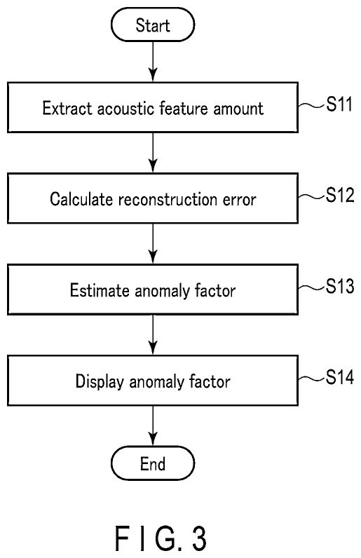

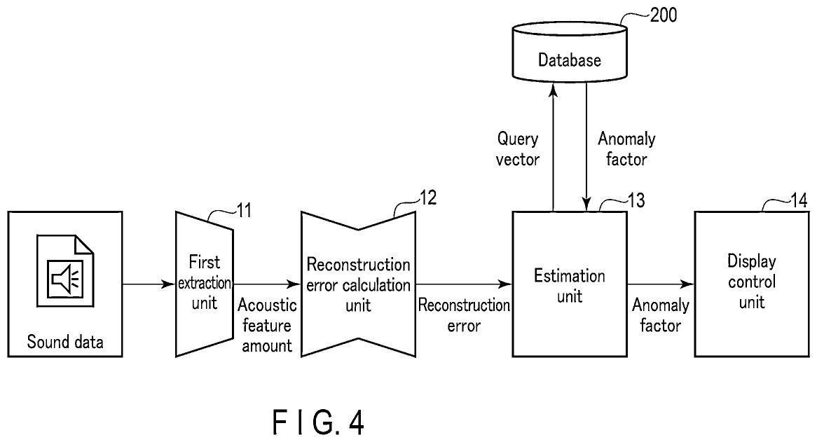

FIG. 3 is a diagram illustrating a processing procedure for estimating an anomaly factor of the target facility 300 according to the first embodiment. FIG. 4 is a diagram schematically illustrating a processing procedure according to the first embodiment. Hereinafter, a process of estimating an anomaly factor of the target facility 300 according to the first embodiment will be described along the flows of FIGS. 3 and 4.

As illustrated in FIG. 3, the first extraction unit 11 extracts an acoustic feature amount defined by a frequency, a time, and a signal intensity from sound data related to the target facility 300 (step S11). The sound data is input via a microphone of the input device 3, for example. However, the sound data may be input from the microphone 34 outside the information processing apparatus 100 via the communication device 5, or the sound data acquired from the microphone 34 may be edited and input to the information processing apparatus 100. The data type of the acoustic feature amount is a vector or an image. As an example, the first extraction unit 11 performs Fourier transformation on the sound data and extracts an acoustic feature amount as a spectrogram or a mel spectrogram image. The sound data may be data having a finite time in which Fourier transformation can be performed and in which an anomalous component can be identified. Specifically, the finite time is about one second. The spectrogram and the mel spectrogram are graphs representing a distribution of signal intensity of sound data in a two-dimensional space of frequency and time. This allows the sound data to be converted into data-type acoustic feature amount that can be easily checked by the user.

When step S11 is performed, the reconstruction error calculation unit 12 calculates a first reconstruction error that is a difference between the reconstructed feature amount obtained by reconstructing the acoustic feature amount extracted in step S11 and the acoustic feature amount extracted in step S11 based on the reconstruction model (step S12). In step S12, the reconstruction error calculation unit 12 first applies the acoustic feature amount extracted in step S11 to the reconstruction model, and encodes and decodes the acoustic feature amount to calculate a reconstructed acoustic feature amount (hereinafter, reconstructed feature amount). Next, the reconstruction error calculation unit 12 calculates the first reconstruction error that is a difference between the reconstructed feature amount and the acoustic feature amount extracted in step S11.

The reconstruction model is a machine learning model into which an acoustic feature amount is input and from which an acoustic feature amount obtained by encoding and decoding the input acoustic feature amount is output. For example, an auto encoder in which a decoder and an encoder are coupled may be used as the reconstruction model. The reconstruction model is generated by the information processing apparatus 100 or another computer. Hereinafter, an apparatus that generates a reconstruction model will be referred to as a training apparatus. The training apparatus trains the reconstruction model by optimization calculation based on training data that is an acoustic feature amount (hereinafter, correct acoustic feature amount) extracted from normal sound data collected when the target facility 300 is normally operated. More specifically, the training apparatus inputs the correct acoustic feature amount to the untrained reconstruction model to calculate the predicted acoustic feature amount, and updates the weight parameter and parameters such as the bias of the untrained reconstruction model so as to minimize the error between the correct acoustic feature amount and the predicted acoustic feature amount. The parameter update is repeated until a predetermined stop condition is satisfied. A set of parameters with which a predetermined stop condition is satisfied is assigned to the untrained reconstruction model, whereby the trained reconstruction model is completed. The data type of the first reconstructed feature amount may be of the same data type as the acoustic feature amount. Extracting the acoustic feature amount using the reconstruction model makes it possible to analyze anomaly based on a plurality of components including frequency and time.

When step S12 is performed, the estimation unit 13 estimates an anomaly factor of the target facility 300 by performing vector search in the database with a query vector based on the first reconstruction error calculated in step S12 (step S13). Specifically, the estimation unit 13 generates the query vector based on the first reconstruction error. The estimation unit 13 performs vector search in the database 200 with the generated query vector. The estimation unit 13 estimates an anomaly factor of the target facility 300 from the database 200 by the vector search. The query vector is a vector that serves as a reference for neighborhood search in vector search. The database 200 stores a plurality of anomaly factors and a plurality of sample vectors based on a plurality of second reconstruction errors in association with each other. The second reconstruction error is a reconstruction error of a past case calculated by the reconstruction error calculation unit 12 or the like in a sampling facility similar to the target facility 300 and/or simulation of the sampling facility. The anomaly factor associated with the second reconstruction error is an anomaly factor in the sampling facility and/or the simulation of the sampling facility. The second reconstruction error may include a reconstruction error calculated from the target facility 300 itself.

More specifically, the estimation unit 13 estimates, as the anomaly factor of the target facility 300, an anomaly factor corresponding to a specific sample vector whose similarity with the query vector exceeds a first threshold among the plurality of sample vectors. The sample vector is obtained by vectorizing (embedding) the second reconstruction error, for example. The query vector is preferably obtained by vectorizing the first reconstruction error through processing similar to that on the sample vector. Specifically, if the first reconstruction error is in an image of a spectrogram or a mel spectrogram, the estimation unit 13 vectorizes the first reconstruction error using a convolutional neural network (CNN). For indication of the similarity, a Euclidean distance, a cosine similarity, a Manhattan distance, a Hamming distance, a Mahalanobis distance, or the like between a plurality of sample vectors and a query vector in a vector space may be used. As a vector search method, a nearest neighbor algorisms search (NN), a k-nearest neighbor algorisms search (kNN), and an approximate nearest neighbor algorisms search (aNN) are used, for example. Using vector search for estimation of an anomaly factor saves the user the time and effort of designing correspondence between various anomaly factors and reconstruction errors.

However, the estimation unit 13 may store the first reconstruction error in the storage device 2 in association with a query vector different from the query vector obtained by vectorizing the first reconstruction error. Hereinafter, among the plurality of sample vectors, a specific sample vector whose similarity with the query vector exceeds the first threshold will be referred to as a similarity vector.

When step S13 is performed, the display control unit 14 displays the anomaly factor of the target facility 300 estimated in step S13 (step S14). As an example, the display control unit 14 displays a display screen for indicating the anomaly factor of the target facility 300 on the display device 4. It is preferable that the first acoustic feature amount input to the reconstruction error calculation unit, the reconstructed feature amount, the reconstruction error, and the anomaly factor and the second reconstruction error associated with the similarity vector are displayed on the display screen.

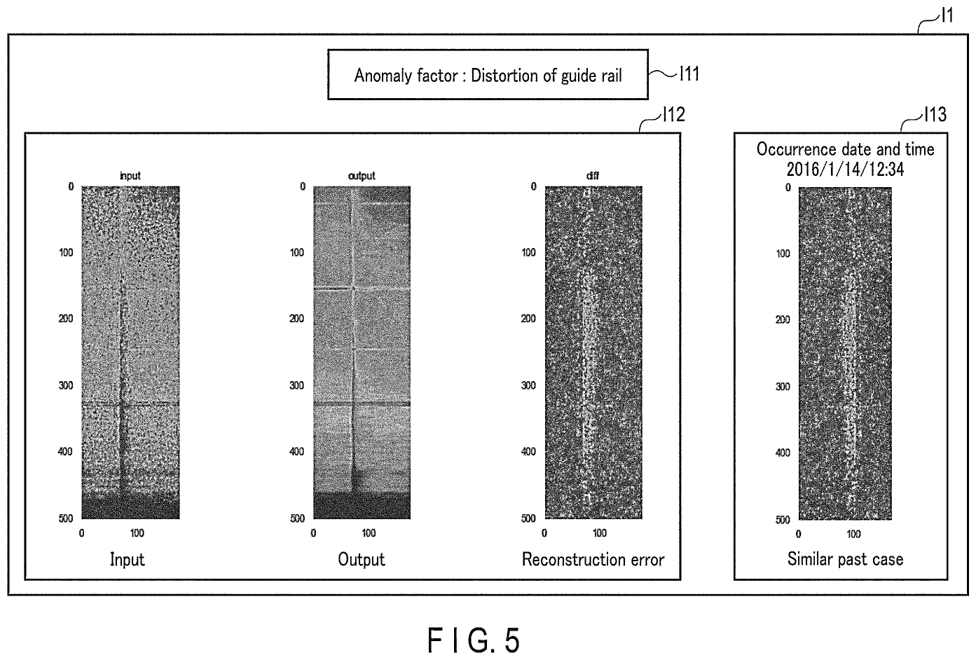

FIG. 5 is a diagram illustrating a display screen I1 for displaying an anomaly factor. The display screen I1 in FIG. 5 includes a display field I11. In the display field I11, a character string indicating an anomaly factor of the target facility 300 such as “distortion of guide rail” is displayed. Spectrograms are displayed on the display screen I1. The spectrograms displayed on the display screen I1 are preferably a spectrogram I12 related to the first reconstruction error and a spectrogram I13 of the second reconstruction error associated with the similarity vector. The vertical axes of the spectrograms I12 and I13 represent frequency. The horizontal axes represent time. Color tone represents signal intensity. The spectrogram I12 in FIG. 5 illustrates, from the left, a first acoustic feature amount, a reconstructed feature amount, and a first reconstruction error. The date and time information displayed on the display screen I1 in FIG. 5 is information on the date and time when the similarity vector was generated. In this case, it is preferable that the sample vector and the generation date and time of the sample vector are stored in association with each other in the database. Since the spectrogram I12 and the spectrogram I13 are displayed together, the user can easily check whether the estimation of the anomaly factor of the target facility 300 is appropriate. Displaying the character string indicating the anomaly factor and the information of the generation date and time of the similarity vector allows the user to check the generation interval of the anomaly factor.

This ends the processing procedure for estimating the anomaly factor of the target facility 300.

Note that the processing procedure for estimating the anomaly factor of the target facility 300 illustrated in FIGS. 3 and 4 is an example, and various deletions, additions, and/or changes can be made without departing from the gist of the invention.

The first embodiment will be compared with a comparative example in which an anomaly factor is estimated by a rule-based method. In the comparative example, a frequency feature amount is extracted from sound data, and an anomaly factor is estimated by using the frequency feature amount. However, in the case of sound data including many variations instead of sound data based on a simple operation, if a rule-based method by which to associate anomaly factors in each frequency band is used, it is difficult to design an anomaly factor distribution rule with an increase in the anomaly factor variations. As compared with the comparative example, according to the present embodiment, extracting the frequency feature amount and adopting a vector search for the estimation of the anomaly factor simplifies the association between the anomaly factors and the feature amounts even if the anomaly factor variations increase.

### Second Embodiment

The anomaly factor estimation system according to the first embodiment performs vector search with a query vector based on the first reconstruction error. An anomaly factor estimation system according to a second embodiment performs vector search with a query vector based on a first frequency feature amount and a first time feature amount extracted from a first reconstruction error. Hereinafter, the anomaly factor estimation system according to the second embodiment will be described. Components having the same functions as those of the first embodiment will be denoted by the same reference signs, and redundant description thereof will be given only when necessary.

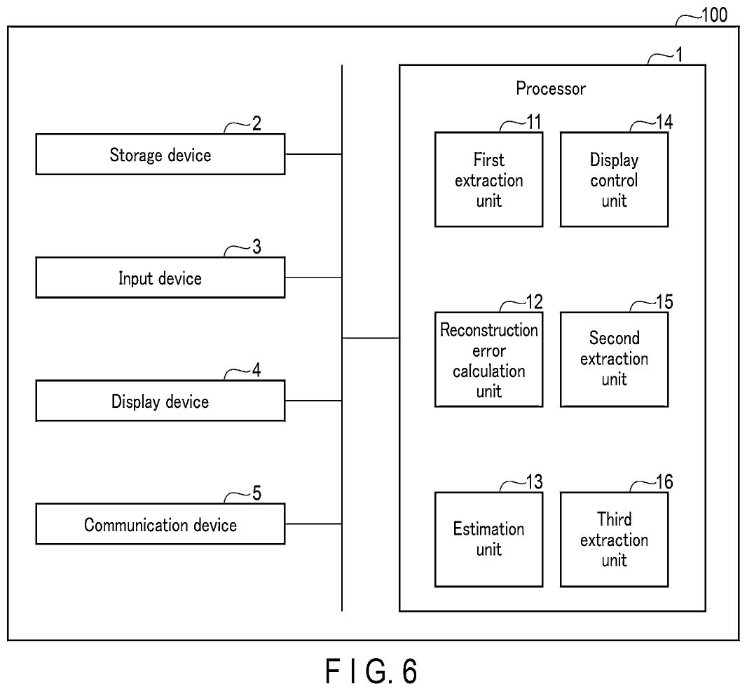

FIG. 6 is a diagram illustrating a hardware configuration example of an information processing apparatus 100 according to the second embodiment. As illustrated in FIG. 6, the processor 1 includes functional components such as a first extraction unit 11, a reconstruction error calculation unit 12, an estimation unit 13, a display control unit 14, a second extraction unit 15, a third extraction unit 16, and the like.

The second extraction unit 15 extracts a first frequency feature amount from a first reconstruction error calculated by the reconstruction error calculation unit 12. For example, the second extraction unit 15 compresses the first reconstruction error in the time direction to extract the first frequency feature amount representing the spatial frequency distribution of the signal intensity of the sound data.

The third extraction unit extracts a first time feature amount from the first reconstruction error. For example, the third extraction unit compresses the first reconstruction error in the frequency direction to extract the first time feature amount representing the spatial time distribution of the signal intensity of the sound data.

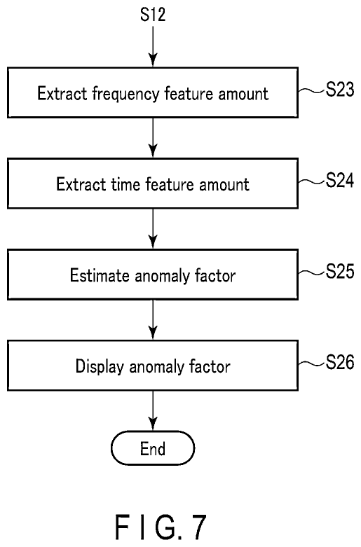

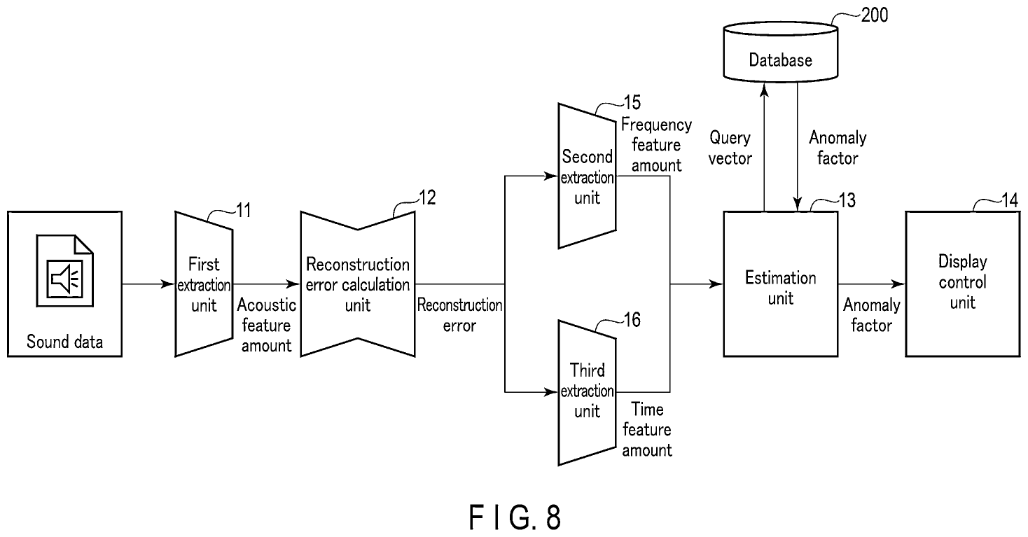

FIG. 7 is a diagram illustrating a processing procedure for estimating an anomaly factor of a target facility 300 according to the second embodiment. FIG. 7 illustrates a processing procedure from step S12 to the end of the processing illustrated in FIG. 3. FIG. 8 is a diagram schematically illustrating a processing procedure according to the second embodiment. Also in the second embodiment, as in the first embodiment, the processor 1 extracts the acoustic feature amount from the sound data in step S11 and calculates the reconstruction error in step S12.

As illustrated in FIG. 7, when step S12 is performed, the second extraction unit 15 extracts the first frequency feature amount from the first reconstruction error calculated in step S12 (step S23). As an example, the second extraction unit 15 obtains the first frequency feature amount by compressing the first reconstruction error in the time direction. In the compression process performed by the second extraction unit 15, calculations of the sum of signal intensities at each frequency, the maximum value of signal intensities, and the time average of signal intensities may be used. Specifically, the second extraction unit 15 obtains a frequency spectrum by calculating the sum of signal intensities of the first reconstruction errors at each frequency. The frequency spectrum includes a distribution of frequency peak of an anomalous component having a higher signal intensity than other frequencies, for example. The first frequency feature amount may be calculated as the distribution of the frequency peak of the anomalous component.

When step S23 is performed, the third extraction unit 16 extracts the first time feature amount from the first reconstruction error calculated in step S12 (step S24). As an example, the third extraction unit 16 obtains the first time feature amount by compressing the first reconstruction error in the frequency direction. In the compression process performed by the third extraction unit 16, calculations of the sum of signal intensities at each time, the maximum value of signal intensities, and the ensemble average of signal intensities may be used. Specifically, the third extraction unit 16 calculates the sum of signal intensities of the reconstruction errors at each time, thereby obtaining a waveform representing the temporal change in the sum of the signal intensities as the first time feature amount. The waveform represents generation timing and duration of an anomalous component having a higher signal intensity than other times, for example. The duration is a time during which the signal strength exceeding the second threshold continues. The second threshold may be set to a value with which the anomalous component and the normal component can be separated. The first time feature amount may be calculated as the generation timing and the duration of the anomalous component.

Since the second extraction unit and the third extraction unit extract the first frequency feature amount and the first time feature amount from the first reconstruction error, it is possible to more easily classify the anomaly factor than the first reconstruction error. Steps S23 and S24 may be performed in reverse order or simultaneously.

When step S23 is performed, the estimation unit 13 performs vector search in the database 200 with a query vector based on the first frequency feature amount and the first time feature amount extracted in step S23 (step S24). Specifically, the estimation unit 13 generates one query vector based on the first frequency feature amount and the first time feature amount, and searches the database with the query vector. The database according to the second embodiment stores a plurality of anomaly factors and a plurality of sample vectors based on a combination of pluralities of second frequency feature amounts and second time feature amounts in association with each other. The plurality of anomaly factors is classified according to a combination of the frequency distribution related to the second frequency feature amount and the duration of the anomalous component in the second time feature amount. The second frequency feature amount and the second time feature amount are feature amounts extracted from the second reconstruction error. Reducing the dimensions of the standard vectors stored in the database 200 makes it possible to speed up vector search. In addition, the storage resources of the database 200 can be saved. The estimation unit 13 may generate one query vector from one feature amount obtained by combining the first frequency feature amount and the first time feature amount, or may generate one query vector by merging a frequency vector generated based on the first frequency feature amount and a time vector generated based on the first time feature amount.

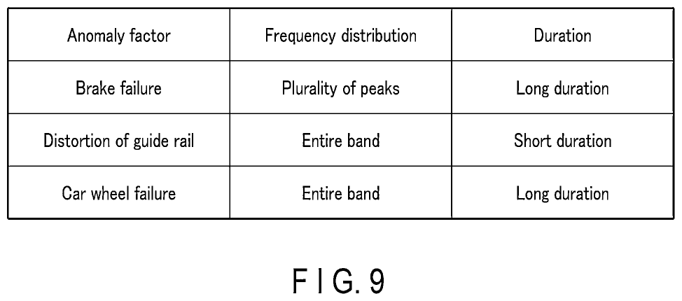

FIG. 9 is a diagram illustrating a typical example of a plurality of classified anomaly factors. As illustrated in FIG. 9, the anomaly factors are preferably classified according to the distribution of the frequency peak of the anomalous component and the duration of the anomalous component. In FIG. 9, an elevator is taken as an example of the target facility 300, but the present invention is not limited to this example. Specifically, the anomaly factors are classified into at least three types, that is, brake failure, distortion of the guide rail, and car wheel failure. The brake failure is a type having a plurality of peaks in a frequency distribution and a long duration. The distortion of the guide rail is a type having a signal intensity equal to or greater than a predetermined threshold in substantially the entire band of the audible range in a frequency distribution and having a short duration. The car wheel failure is a type having a signal intensity equal to or greater than a predetermined threshold in substantially the entire band of the audible range in a frequency distribution and having a long duration. The long duration indicates that the duration is longer than a predetermined threshold. The short duration indicates that the duration is shorter than the predetermined threshold. More specifically, the predetermined threshold of the duration is approximately one second. The predetermined threshold may be set to any value with which the anomaly factors can be classified.

The estimation unit 13 may perform vector search using a value based on the duration of the signal intensity exceeding a second threshold and a deviation based on the duration for two or more sample vectors associated with the same anomaly factor among the plurality of sample vectors. As an example, the duration is calculated as the first time feature amount by the third extraction unit 16. The value based on the duration is a value corresponding to vectorization of the duration. However, the value based on the duration may be the duration itself. The deviation of the value based on the duration is preferably calculated for each of two or more sample vectors associated with the same anomaly factor. More specifically, the estimation unit 13 sets a predetermined threshold for the standard deviation using the standard deviation of the duration for two or more sample vectors associated with the same anomaly factor, thereby to associate the duration up to the predetermined threshold with the anomaly factor. Performing vector search in the database with respect to the duration improves the accuracy of searching for an anomaly factor having variation in the duration.

When step S24 is performed, the display control unit 14 displays the anomaly factor of the target facility 300 estimated in step S24 (step S25). As an example, the display control unit 14 displays spectra of the first frequency feature amount and the second frequency feature amount so as to overlap each other. As another example, the display control unit 14 displays waveforms of the first time feature amount and the second time feature amount so as to overlap each other.

FIG. 10 is a diagram illustrating a display screen I2 for displaying an anomaly factor. The display screen I2 in FIG. 10 includes a display field I21. In the display field I21, a character string indicating an anomaly factor of the target facility such as “distortion of guide rail” is displayed. A spectrum and/or a waveform are displayed on the display screen 12. For example, a spectrum 122 in which the spectrum of the first frequency feature amount and the spectrum of the second frequency feature amount associated with the similarity vector are superimposed is preferably displayed on the display screen 12. In addition, a waveform 123 in which the waveform of the first time feature amount and the waveform of the second time feature amount associated with the similarity vector are superimposed is preferably displayed on the display screen 12. The vertical axis of the spectrum I22 indicates signal intensity, and the horizontal axis indicates frequency. The vertical axis of the waveform I23 indicates signal intensity, and the horizontal axis indicates time. Since the spectrum 122 and the waveform 123 are displayed on the display screen I2, the user can easily compare the first frequency feature amount related to the query vector and the second frequency feature amount related to the similarity vector, and/or compare the first time feature amount related to the query vector and the second time feature amount related to the similarity vector. Other information such as the occurrence dates and times of the second frequency feature amount and the second time feature amount may be further displayed on the display screen I2.

This ends the processing procedure for estimating the anomaly factor of the target facility 300.

Note that the processing procedure for estimating the anomaly factor of the target facility 300 illustrated in FIGS. 7 and 8 is an example, and various deletions, additions, and/or changes can be made without departing from the gist of the invention.

The second embodiment will be compared with a comparative example in which an anomaly factor is estimated without using a time feature amount of sound data. In the comparative example, a frequency feature amount is extracted from sound data, and an anomaly factor is estimated by using the frequency feature amount. However, if the sound data is not sound data based on a simple operation but sound data including many variations, the anomaly factor is insufficiently estimated unless there is time-related information. As compared with the comparative example, according to the present embodiment, it is possible to estimate many anomaly factor variations by extracting and using the frequency feature amount and the time feature amount.

### Third Embodiment

In the first embodiment and the second embodiment, the anomaly factor estimation system performs vector search with a query vector based on the first reconstruction error. In a third embodiment, in order to newly store a query vector based on a first reconstruction error as a sample vector, an anomaly factor estimation system inputs the query vector, the first reconstruction error, a first frequency feature amount, and/or a first time feature amount to a database in association with one another. Hereinafter, the anomaly factor estimation system according to the third embodiment will be described. In the following description, components having substantially the same functions as those of the first embodiment or the second embodiment will be denoted with the same reference numerals, and redundant description thereof will be given only when necessary.

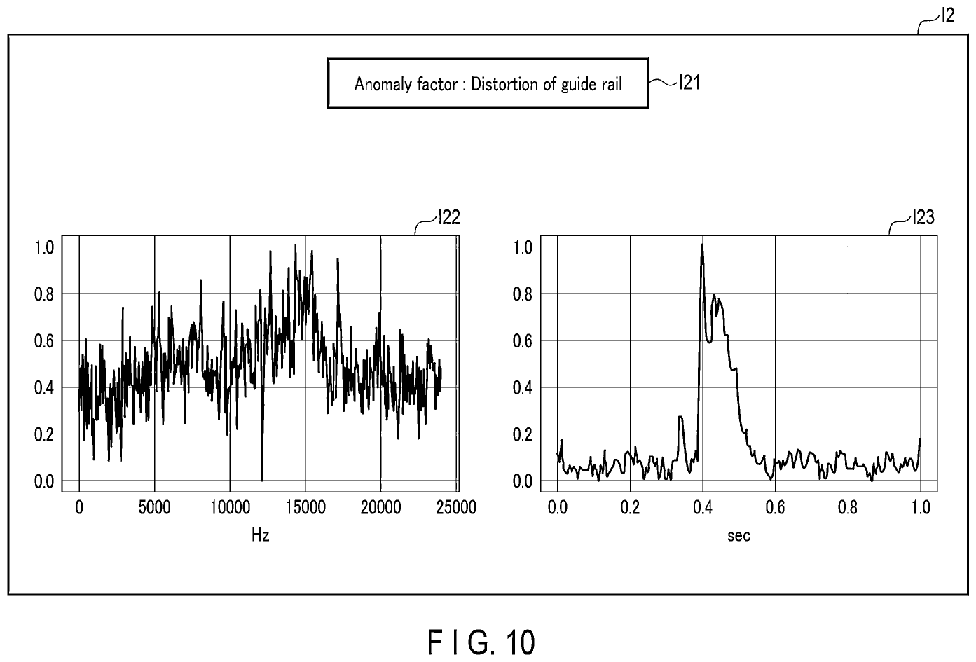

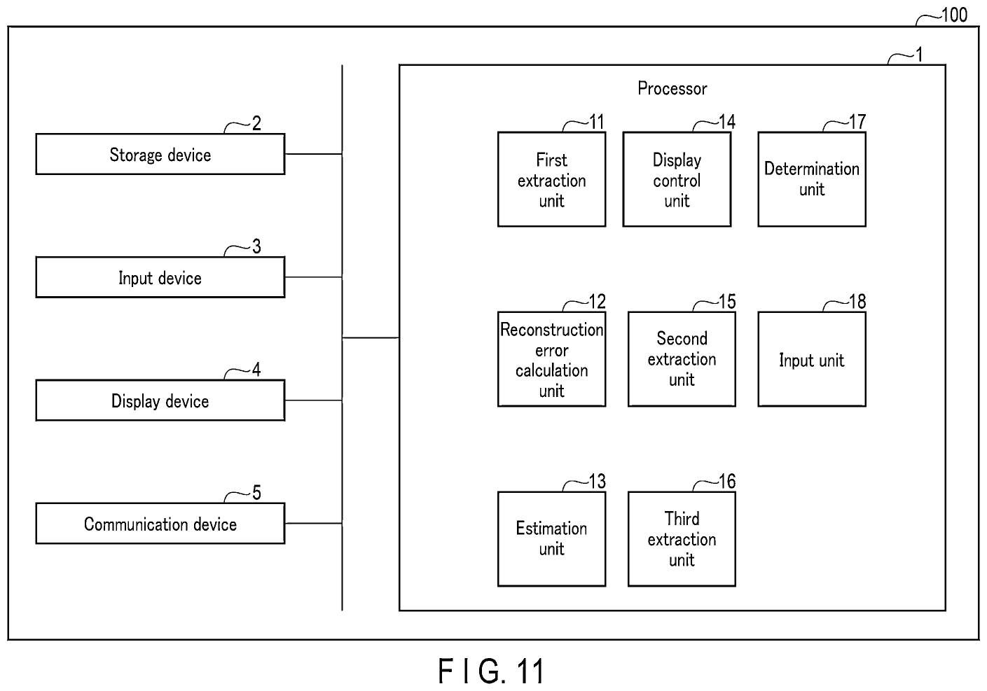

FIG. 11 is a diagram illustrating a hardware configuration example of an information processing apparatus 100 according to the third embodiment. As illustrated in FIG. 11, a processor 1 has functional components such as a first extraction unit 11, a reconstruction error calculation unit 12, an estimation unit 13, a display control unit 14, a second extraction unit 15, and a third extraction unit 16, a determination unit 17, and an input unit 18.

The determination unit 17 determines whether sound data is normal based on the first reconstruction error calculated by the reconstruction error calculation unit 12.

The input unit 18 inputs another sample vector and an anomaly factor to the database 200 in association with each other under a user's instruction. The other sample vector represents a sample vector that is different from the sample vector stored in the database 200 in advance. In particular, the query vector used for estimation that is to be stored as a new sample vector in the database 200 will be referred to as other sample vector.

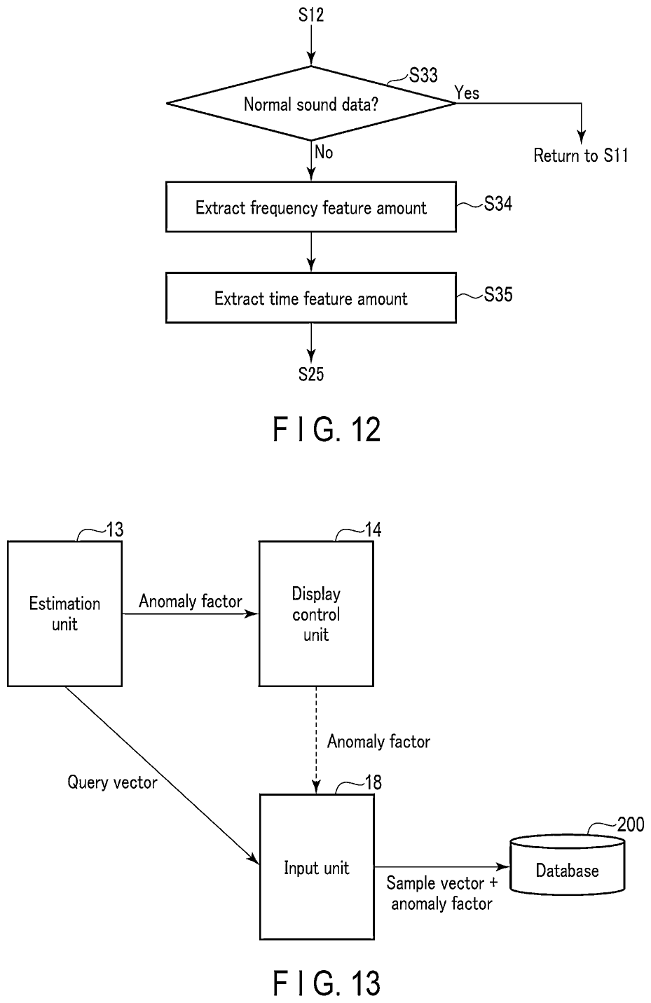

FIG. 12 is a diagram illustrating a processing procedure for estimating an anomaly factor of a target facility 300 according to the third embodiment. FIG. 12 illustrates a processing procedure from step S12 illustrated in FIG. 3 to step S25 illustrated in FIG. 7. Also in the third embodiment, as in the second embodiment, the processor 1 extracts the acoustic feature amount from the sound data in step S11 and calculates the reconstruction error in step S12.

As illustrated in FIG. 12, when step S12 is performed, the determination unit 17 determines whether the sound data used for extracting the first acoustic feature amount in step S11 is normal based on the first reconstruction error calculated in step S12 (step S33). If the anomaly score of the first reconstruction error exceeds a third threshold value, the determination unit 17 determines that the input sound data is not normal. The anomaly score is a sum or a maximum value of the first reconstruction errors, for example. If it is determined in step S11 that the sound data used for extracting the first acoustic feature amount is normal (step S33: YES), the determination unit 17 performs step S11. Since the first frequency feature amount and the first time feature amount are not extracted for sound data determined to be normal, it is possible to improve the efficiency of estimating the anomaly factor of an anomaly factor estimation system 600.

If it is determined in step S11 that the sound data used for extracting the first acoustic feature amount is not normal (step S33: NO), the second extraction unit extracts the first frequency feature amount from the first reconstruction error calculated in step S12 (step S34).

When step S34 is performed, the third extraction unit extracts the first time feature amount from the first reconstruction error calculated in step S12 (step S35).

Steps S34 and S35 may be performed in reverse order or simultaneously. If step S35 is to be performed before or after step S34, step S35 is preferably executed if it is determined in step S11 that the sound data used for extracting the first acoustic feature amount is not normal. If it is determined that the sound data is not normal, the display control unit 14 may display the reconstruction error, the frequency feature amount, the time feature amount, and/or the anomaly factor related to the sound data.

This ends the processing procedure for estimating the anomaly factor of the target facility 300.

Next, a processing procedure for storing the estimated anomaly factor of the target facility 300 and another sample vector in the database 200 in association with each other will be described. In the following description, a process is started after the anomaly factor of the target facility 300 is estimated, in other words, from a time point at which the process in FIG. 12 is ended.

FIG. 13 is a diagram schematically illustrating a processing procedure related to the input unit 18 according to the third embodiment.

The input unit 18 inputs the other sample vector and the anomaly factor to the database 200 under a user's instruction. For example, the input unit 18 inputs the query vector calculated by the estimation unit 13 to the database 200 as the other sample vector under a user's instruction. However, the input unit 18 may input the query vector calculated by the estimation unit 13 and then stored in the storage device 2 to the database 200 as the other sample vector. The input unit 18 may also input the anomaly factor displayed by the display control unit 14 and the other sample vector in association with each other under a user's instruction. However, the input unit 18 may input an anomaly factor other than the anomaly factor displayed by the display control unit 14.

This ends the processing procedure for storing the estimated anomaly factor of the target facility 300 and the other sample vector in the database 200 in association with each other.

Note that the processing procedure for estimating the anomaly factor of the target facility 300 illustrated in FIG. 12 and the processing procedure for inputting the other sample vector and the anomaly factor in association with each other to the database 200 illustrated in FIG. 13 are examples, and various deletions, additions, and/or changes can be made without departing from the gist of the invention.

According to the third embodiment, it is possible to extract the frequency feature amount and the time frequency according to the anomaly score. This makes it possible to efficiently extract the frequency feature amount and the time feature amount for anomalous sound data among acquired sound data, and eventually, makes it possible to store the query vector based on the extracted frequency feature amount and time feature amount in the database 200 as another sample vector.

### Fourth Embodiment

The anomaly factor estimation systems according to the first embodiment, the second embodiment, and the third embodiment determine anomaly based on the length of the acquired sound data. In an anomaly factor estimation system according to a fourth embodiment, if the operating sound of a target facility 300 is over a long time, it is determined whether sound data is anomalous by dividing the sound data acquired over a longer time into shorter pieces. Specifically, sound data of about 10 seconds is divided into sound data of about 1 second. The length of the sound data to be acquired and the length of the divided sound data are not limited to the above lengths. Hereinafter, the anomaly factor estimation system according to the fourth embodiment will be described. In the following description, components having substantially the same functions as those of the first embodiment, the second embodiment, or the third embodiment will be denoted with the same reference numerals, and redundant description thereof will be given only when necessary.

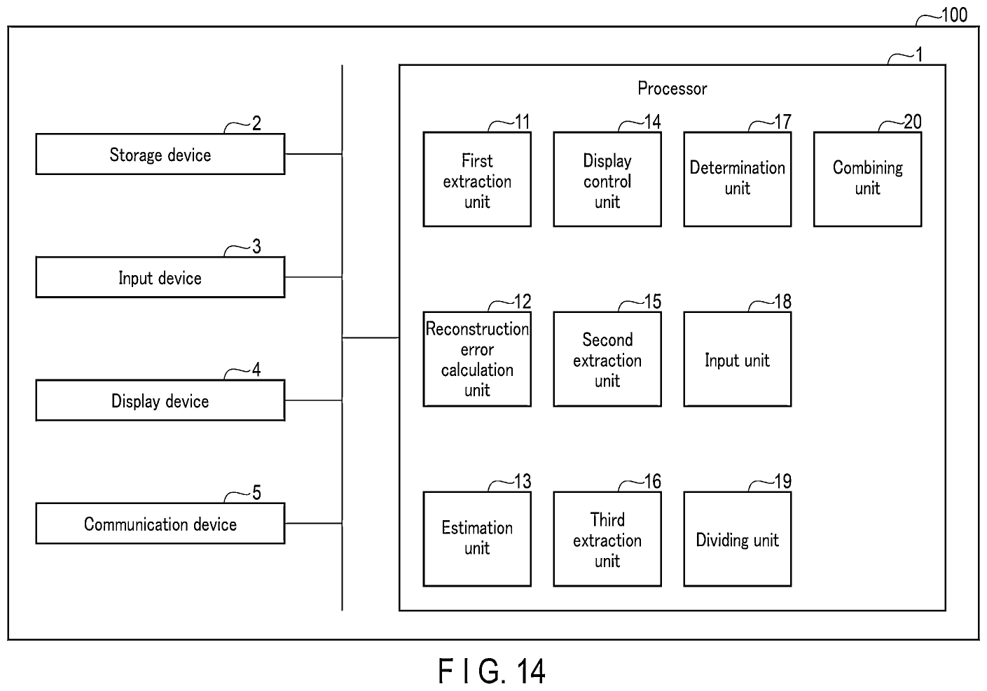

FIG. 14 is a diagram illustrating a hardware configuration example of an information processing apparatus 100 according to the fourth embodiment. As illustrated in FIG. 14, a processor 1 has functional components such as a first extraction unit 11, a reconstruction error calculation unit 12, an estimation unit 13, a display control unit 14, a second extraction unit 15, and a third extraction unit 16, a determination unit 17, an input unit 18, a dividing unit 19, and a combining unit 20.

The dividing unit 19 divides the sound data into a plurality of segments at predetermined time intervals.

If the determination unit 17 determines that the plurality of segments continuous in chronological order divided by the dividing unit 19 is not normal, the combining unit 20 combines a plurality of reconstruction errors corresponding to the plurality of segments to generate a first reconstruction error.

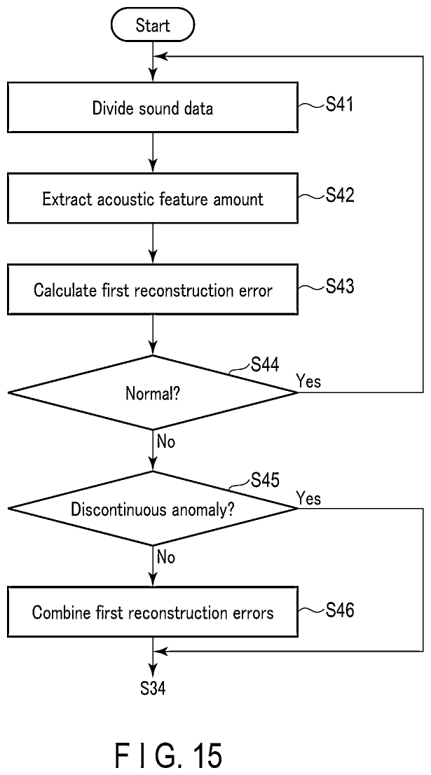

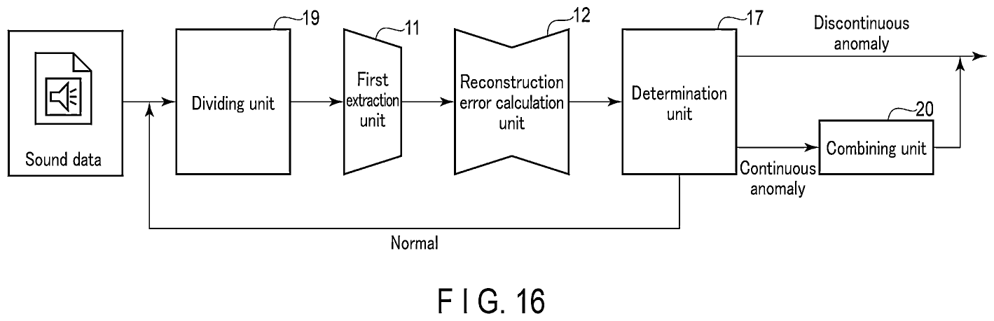

FIGS. 15 and 16 are diagrams illustrating a processing procedure for estimating an anomaly factor of a target facility 300 according to the fourth embodiment.

As illustrated in FIG. 15, the dividing unit 19 divides the sound data into a plurality of segments at predetermined time intervals (step S41). More specifically, the sound data is divided in chronological order. The plurality of segments is preferably the same in data type as the sound data. In other words, each of the plurality of segments is preferably treated as sound data of a shorter time than the sound data before being divided. For example, the dividing unit 19 edits the digital signals of the vicinities of the start and end in the chronological order of each of the plurality of segments, in a manner capable of a Fourier transformation. An elevator is taken as an example of the target facility 300, but the present invention is not limited to this example. In order to estimate an anomaly factor such as a lifting distance of the car of the elevator or a different operation between opening and closing of the door of the elevator and lifting and lowering of the car, sound data of a length suitable for each anomaly is required. Dividing the sound data into a plurality of segments makes it possible to classify the sound data for each operation targeting an anomaly.

The predetermined interval may be set to any time shorter than the length of the sound data. The plurality of divided segments may be subjected to the process described below while holding the information regarding the chronological order of the sound data. As an example, the information regarding the chronological order is information regarding the time of the sound data before being divided. As another example, if the sound data is divided in chronological order, the information regarding the chronological order is the order in which the dividing unit 19 divided the sound data into the plurality of segments.

When step S41 is performed, the first extraction unit 11 extracts a first acoustic feature amount from each of the plurality of segments divided in step S41 (step S42). In the fourth embodiment, as in the first embodiment, the first extraction unit 11 extracts an acoustic feature amount from the plurality of divided segments.

When step S42 is performed, the reconstruction error calculation unit 12 calculates a plurality of reconstruction errors corresponding to the plurality of first acoustic feature amounts extracted in step S42 based on a reconstruction model (step S43). The reconstruction model is a machine learning model trained by optimization calculation based on training data that include correct acoustic feature amounts extracted from a plurality of normal segments divided from normal sound data collected while the target facility 300 is normally operated, for example. Using the reconstruction model trained on the normal segments makes it possible to improve the efficiency of detecting an anomalous component of a time shorter than the sound data.

When step S43 is performed, the determination unit 17 determines whether each of the plurality of segments divided in step S41 is normal based on the first reconstruction error calculated in step S43 (step S44). If the anomaly score of at least one reconstruction error among the plurality of reconstruction errors exceeds the third threshold, the determination unit 17 may determine that the segment used to calculate the reconstruction error in which the degree of anomaly exceeds the third threshold is not normal. The anomaly score is a sum or a maximum value of one reconstruction error among a plurality of reconstruction errors, for example. The third threshold may be set to a value different from the value in the third embodiment. The determination unit 17 determines whether each of the plurality of segments is normal.

If it is determined that all of the plurality of segments divided in step S41, which have been used for calculation of the first reconstruction errors in step S43, are normal (step S44: YES), the dividing unit 19 performs step S41.

If it is determined that at least one segment among the plurality of segments divided in step S41, which has been used for calculation of the first reconstruction error in step S43, is not normal (step S44: NO), the determination unit 17 determines whether the plurality of segments continuous in chronological order is normal (step S45). The plurality of segments continuous in chronological order is two or more segments continuous in the chronological order of the sound data divided from the same sound data. For example, the determination unit 17 determines whether the segments determined as anomalous are continuous in chronological order based on the information regarding the chronological order of the segments determined as anomalous in step S44. For example, it is determined whether the segments determined as anomalous are continuous in chronological order based on the information regarding the chronological order.

If the plurality of segments continuous in chronological order is determined as normal (step S45: YES), the second extraction unit 15 performs the same processing as that in step S34 and the subsequent steps of the third embodiment on each of the segments determined as anomalous in step S44.

If it is determined that the plurality of segments continuous in chronological order is not normal (step S45: NO), the combining unit 20 combines the plurality of reconstruction errors calculated in step S43 to generate a first reconstruction error (step S46). For example, the combining unit 20 combines the plurality of segments continuous in chronological order to generate a first reconstruction error. The combining unit 20 may combine all the plurality of reconstruction errors to generate one first reconstruction error, or may combine some of the plurality of reconstruction errors to generate a plurality of first reconstruction errors. By combining the plurality of reconstruction errors to generate a first reconstruction error, it is possible to perform vector search for an anomaly factor of a time longer than the divided time.

When step S46 is performed, the second extraction unit 15 performs the same processing as that in step S34 and the subsequent steps of the third embodiment on the first reconstruction error generated in step S46. If the plurality of first reconstruction errors is generated in step S46, the second extraction unit 15 performs the same processing as that in step S34 and the subsequent steps of the third embodiment on each of the plurality of first reconstruction errors.

This ends the processing procedure for estimating the anomaly factor of the target facility 300.

Note that the processing procedure for estimating the anomaly factor of the target facility 300 illustrated in FIGS. 15 and 16 is an example, and various deletions, additions, and/or changes can be made without departing from the gist of the invention. In the fourth embodiment, the database may store the sample vector based on the first reconstruction error calculated from the divided segments and the anomaly factor in association with each other. As an example, the sample vector is based on a segment in which all of the segments are combined, a segment in which some of the segments are combined, and/or one segment. The hardware configuration including the dividing unit 19 can also be implemented without the second extraction unit 15, the third extraction unit 16, and the determination unit 17. Specifically, the present invention is also applicable to a configuration in which the dividing unit 19 is added to the hardware configuration of the first embodiment.

According to the fourth embodiment, it is possible to estimate an anomaly factor of a short time by dividing collected sound data in units of short time. It is also possible to estimate an anomaly factor of a time longer than the divided time by combining the divided segments in chronological order.

### Fifth Embodiment

The anomaly factor estimation systems according to the first embodiment, the second embodiment, the third embodiment, and the fourth embodiment use a trained reconstruction model for calculation of a reconstruction error. An anomaly factor estimation system in the fifth embodiment generates a trained reconstruction model. Hereinafter, the anomaly factor estimation system according to the fifth embodiment will be described. In the following description, components having substantially the same functions as those of the first embodiment, the second embodiment, the third embodiment, or the fourth embodiment will be denoted with the same reference numerals, and redundant description thereof will be given only when necessary.

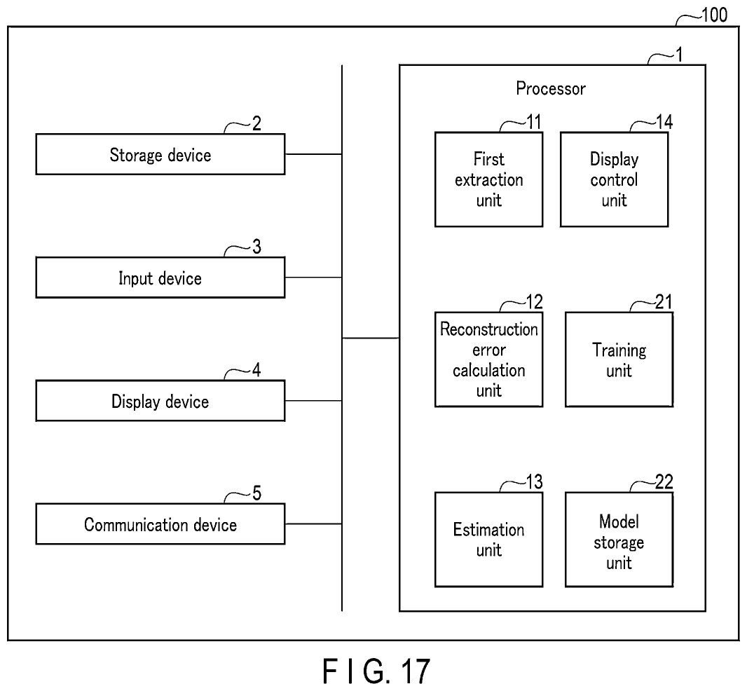

FIG. 17 is a diagram illustrating a hardware configuration example of an information processing apparatus 100 according to the fifth embodiment. As illustrated in FIG. 17, a processor 1 includes functional components such as a first extraction unit 11, a reconstruction error calculation unit 12, an estimation unit 13, a display control unit 14, a training unit 21, and a model storage unit 22.

The training unit 21 inputs a correct acoustic feature amount based on training data that is the correct acoustic feature amount extracted by the first extraction unit 11, and generates a reconstruction model that is trained to output data of encoding and decoding of the input correct acoustic feature amount.

The model storage unit 22 stores the reconstruction model. As an example, the model storage unit 22 stores the reconstruction model in a storage device 2.

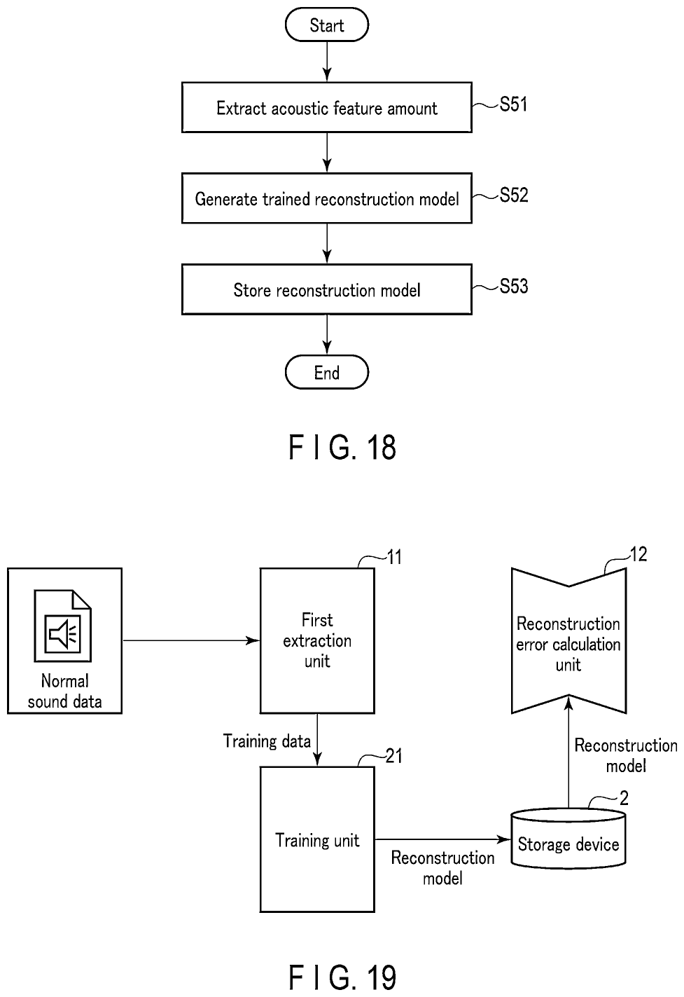

FIGS. 18 and 19 are diagrams illustrating a processing procedure for generating a reconstruction model according to the fifth embodiment. Hereinafter, a process of generating a reconstruction model according to the fifth embodiment will be described along the flows of FIGS. 18 and 19. The processing of generating a reconstruction model is preferably performed before the processing of estimating an anomaly factor performed in the first to fourth embodiments. More specifically, the reconstruction models in the first to fourth embodiments are generated in the fifth embodiment.

As illustrated in FIG. 18, the first extraction unit 11 extracts a correct acoustic feature amount, which is training data, from sound data collected when a target facility 300 is normally operated (step S51). The sound data is preferably collected from the target facility 300 whose anomaly factor will be estimated. Specifically, the correct acoustic feature amount is extracted from the sound data of the target facility 300 collected from a microphone 34. This makes it possible to acquire training data having characteristics specific to the installation environment of the target facility 300 and/or the mechanism of the target facility 300.

The training data is stored in a training data memory. The training data memory is a storage device 2 or a database 200, for example. By using the stored training data for training of a model for use in another target facility having a similar installation environment and/or mechanism, it is possible to shorten the time for collecting and enhancing training data.

When step S51 is performed, the training unit 21 inputs acoustic feature amounts based on the training data extracted in step S51, and generates a reconstruction model trained to output data of encoding and decoding of the input acoustic feature amounts (step S52). More specifically, the training unit 21 inputs the training data to the model to be trained. Next, the training unit 21 evaluates the data output from the model to be trained using the loss function. As the loss function, a mean squared error (MSE), a cross entropy loss (CE Loss), or the like is used, for example. Finally, the training unit 21 determines whether to end the training according to the evaluation result. If the training is not to be ended, the training unit 21 updates the parameters of the model to be trained and inputs the training data to the model to be trained. If the training is to be ended, step S53 is performed. By training the model using the training data based on the normal sound data collected from the target facility 300, it is possible to improve the extraction accuracy of the anomalous component in the generated reconstruction model, independent of the installation environment and/or mechanism of the target facility 300.

The training unit 21 may generate a reconstruction model by providing additional training to a learned reconstruction model using the training data on the installation environment and/or mechanism of the target facility 300, or may generate a reconstruction model by training an untrained reconstruction model using the training data of the installation environment and/or mechanism of the target facility 300. In addition, an auto encoder in which a decoder and an encoder are coupled may be used for the model to be trained.

When step S52 is performed, the model storage unit 22 stores the reconstruction model generated in step S52 (step S53). As an example, the model storage unit 22 stores the generated reconstruction model in the storage device 2. The reconstruction error calculation unit 12 uses the stored reconstruction model, for example. By using the reconstruction model trained by the training unit 21 as the reconstruction error calculation unit 12 in the third embodiment, a highly versatile first reconstruction error that does not depend on the installation environment and/or mechanism of the target facility 300 can be input as a sample vector.

This ends the processing procedure for estimating the anomaly factor of the target facility 300.

Note that the processing procedure for estimating the anomaly factor of the target facility 300 illustrated in FIGS. 18 and 19 is an example, and various deletions, additions, and/or changes can be made without departing from the gist of the invention.

According to the fifth embodiment, it is possible to generate a reconstruction model for use in an anomaly factor estimation system. Furthermore, it is possible to improve the detection accuracy of the anomaly of the target facility 300 by generating a reconstruction model using the correct acoustic feature amount of the target facility 300 as the training data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An anomaly factor estimation system comprising a processor configured to
extract a first acoustic feature amount based on a frequency, a time, and a signal intensity from sound data related to target facility,
calculate a first reconstruction error that is a difference between the first acoustic feature amount and a reconstructed feature amount obtained by reconstructing the first acoustic feature amount based on a reconstruction model for encoding and decoding an acoustic feature amount, and
estimate an anomaly factor of the target facility by performing vector search in a database with a query vector based on the first reconstruction error, wherein
the database stores a plurality of anomaly factors and a plurality of sample vectors based on a plurality of second reconstruction errors in association with each other.

2. The anomaly factor estimation system according to claim 1, wherein the processor estimates an anomaly factor corresponding to a specific sample vector whose similarity to the query vector exceeds a first threshold among the sample vectors, as the anomaly factor of the target facility.

3. The anomaly factor estimation system according to claim 1, wherein the processor displays the anomaly factor of the target facility.

4. The anomaly factor estimation system according to claim 2, wherein the processor displays the anomaly factor of the target facility and side by side a spectrogram based on the first reconstruction error and a spectrogram based on a second reconstruction error associated with the specific sample vector.

5. The anomaly factor estimation system according to claim 4, wherein the processor further displays information on occurrence date and time of the anomaly factor associated with the specific sample vector.

6. The anomaly factor estimation system according to claim 1, wherein the processor performs vector search in the database with the query vector based on a spectrogram regarding the first reconstruction error.

7. The anomaly factor estimation system according to claim 1, wherein
the processor extracts a first frequency feature amount from the first reconstruction error, extracts a first time feature amount from the first reconstruction error, and performs vector search with the query vector based on the first frequency feature amount and the first time feature amount, and
the sample vector is a vector based on a second frequency feature amount and a second time feature amount extracted from the second reconstruction error.

8. The anomaly factor estimation system according to claim 7, wherein the anomaly factors is classified according to a combination of a frequency distribution related to the second frequency feature amount and a duration of an anomalous component in the second time feature amount.

9. The anomaly factor estimation system according to claim 8, wherein
the anomaly factors include a first type, a second type, and a third type,
the first type is a type that has a plurality of peaks in the frequency distribution and of which the duration is equal to or longer than a predetermined time,
the second type is a type of which the signal intensity is equal to or greater than a predetermined threshold in substantially the entire audible range in the frequency distribution, and the duration is equal to or less than the predetermined time, and
the third type is a type of which the signal intensity is equal to or greater than the predetermined threshold in substantially the entire audible range in the frequency distribution, and the duration is longer than the predetermined time.

10. The anomaly factor estimation system according to claim 7, wherein the processor displays spectra of the first frequency feature amount and the second frequency feature amount side by side or so as to overlap each other, and/or displays waveforms of the first time feature amount and the second time feature amount side by side or so as to overlap each other.

11. The anomaly factor estimation system according to claim 7, wherein the processor determines whether the sound data is normal based on the first reconstruction error, extracts the first frequency feature amount from the first reconstruction error and extracts the first time feature amount from the first reconstruction error if it is determined that the sound data is not normal.

12. The anomaly factor estimation system according to claim 11, wherein the processor determines that the sound data is not normal if an anomaly score of the first reconstruction error exceeds a third threshold.

13. The anomaly factor estimation system according to claim 1, wherein the processor inputs another sample vector and an anomaly factor to the database in association with each other under a user's instruction.

14. The anomaly factor estimation system according to claim 11, wherein if it is determined that the sound data is not normal, the processor displays the first reconstruction error, the second reconstruction error, the first frequency feature amount, the second frequency feature amount, the first time feature amount, the second time feature amount, and/or the anomaly factor related to the sound data.

15. The anomaly factor estimation system according to claim 1, wherein the processor divides the sound data into a plurality of segments at predetermined time intervals, and extracts the first acoustic feature amount from each of the segments.

16. The anomaly factor estimation system according to claim 11, wherein the processor divides the sound data into a plurality of segments at predetermined time intervals, and if it is determined that the segments continuous in chronological order are not normal, the processor combines a plurality of reconstruction errors corresponding to the segments to generate the first reconstruction error.

17. The anomaly factor estimation system according to claim 1, further comprising:
a training data memory that stores, as training data, an acoustic feature amount extracted from the normal sound data collected when the target facility is normally operating; wherein
the processor inputs the acoustic feature amount based on the training data, generates the reconstruction model trained to output encoding and decoding data of the input acoustic feature amount, and stores the reconstruction model in a storage device.

18. The anomaly factor estimation system according to claim 1, wherein the processor performs vector search using a value based on a duration of signal intensity exceeding a second threshold and a deviation of the value based on the duration, for two or more sample vectors associated with the same anomaly factor among the sample vectors.

19. An anomaly factor estimation method causing a computer to perform operations comprising:
extracting a first acoustic feature amount based on a frequency, a time, and a signal intensity from sound data related to target facility;
calculating a first reconstruction error that is a difference between the first acoustic feature amount and a reconstructed feature amount obtained by reconstructing the first acoustic feature amount based on a reconstruction model for encoding and decoding an acoustic feature amount; and
estimating an anomaly factor of the target facility by performing vector search in a database with a query vector based on the first reconstruction error, wherein
the database stores a plurality of anomaly factors and a plurality of sample vectors based on a plurality of second reconstruction errors in association with each other.

20. A non-transitory computer readable medium including computer executable instructions, wherein the instructions, when executed by a processor, cause the processor to perform operations comprising:
extracting a first acoustic feature amount based on a frequency, a time, and a signal intensity from sound data related to target facility;
calculating a first reconstruction error that is a difference between the first acoustic feature amount and a reconstructed feature amount obtained by reconstructing the first acoustic feature amount based on a reconstruction model for encoding and decoding an acoustic feature amount; and
estimating an anomaly factor of the target facility by performing vector search in a database with a query vector based on the first reconstruction error, wherein
the database stores a plurality of anomaly factors and a plurality of sample vectors based on a plurality of second reconstruction errors in association with each other.
